(19) United States
(12) Patent Application Publication
(10) Pub. No.: US 2005/0112426 A1
(43) Pub. Date: May 26, 2005

(54) Fuel cell regulation using updating table storage

(75) Inventors: Akos Toth, Etobicoke (CA); Stephen Burany, Thornhill (CA)

Correspondence Address: BERESKIN AND PARR, 40 KING STREET WEST, BOX 401, TORONTO, ON, M5H 3Y2, CA

(73) Assignee: Hydrogenics Corporation, Mississauga (CA)

(21) Appl. No.: 10/926,300

(22) Filed: Aug. 26, 2004

Related U.S. Application Data
(60) Provisional application No. 60/497,551, filed on Aug. 26, 2003.

(51) Int. Cl. H01M 8/04

(52) U.S. Cl. 429/22; 429/13

(57) ABSTRACT

A system and method used to regulate the operation of fuel cell systems. In one embodiment, a fuel cell system comprises a fuel cell stack, the fuel cell stack comprising at least one fuel cell and electric outputs for driving a load; a balance of plant system for supplying and withdrawing process fluids to and from the fuel cell stack; and a controller that controls the operation of the fuel cell stack and the balance of plant system by measuring and setting process parameters; where the controller comprises a storage device adapted to, for at least one of the process parameters, store at least one baseline table of set values of the process parameter and to optionally store at least one correction table of correction values of the process parameter. Correction values are stored in real-time as changes are made to the process parameter during the operation of the fuel cell stack.

### CROSS-REFERENCE TO RELATED APPLICATION

This application claims the benefit of U.S. Patent Application No. 60/497,551, filed Aug. 26, 2003, the contents of which are herein incorporated by reference.

### FIELD OF THE INVENTION

Embodiments of the invention relate generally to fuel cell systems, and more particularly, to systems and methods for regulating the operation of fuel cell systems.

### BACKGROUND OF THE INVENTION

Fuel cell systems are seen as a promising alternative to traditional power generation technologies due to their low emissions, high efficiency and ease of operation. Fuel cells operate to convert chemical energy into electrical energy. Proton exchange membrane fuel cells comprise an anode, a cathode, and a selective electrolytic membrane disposed between the two electrodes. In a catalyzed reaction, a fuel, such as hydrogen, is oxidized at the anode to form cations (protons) and electrons. The proton exchange membrane facilitates the migration of protons from the anode to the cathode. The electrons cannot pass through the membrane and are forced to flow through an external circuit thus providing an electrical current. At the cathode, oxygen reacts at the catalyst layer, with electrons returned from the electrical circuit, to form anions. The anions formed at the cathode react with the protons that have crossed the membrane to form liquid water as the reaction product.

The proton exchange membrane of a fuel cell requires a wet surface to facilitate the conduction of protons from the anode to the cathode, and to otherwise maintain the membrane electrically conductive. However, under certain circumstances, it is possible for the membrane to become insufficiently moist, thereby limiting efficiency of the fuel cell.

For example, in U.S. Pat. No. 5,996,976, it is suggested that each proton that moves through the membrane drags at least two or three water molecules with it. Similarly, in U.S. Pat. No. 5,786,104, a mechanism termed as “water pumping” is described, which involves the transport of cations (protons) together with water molecules through the membrane. As the current density increases, the number of water molecules moved through the membrane also increases. Eventually the flux of water being pulled through the membrane by the proton flux exceeds the rate at which water is replenished by diffusion. At this point the membrane begins to dry out, at least on the anode side, and its internal resistance increases. Furthermore, while this mechanism drives water to the cathode side, and water created by the reaction is formed at the cathode side, it is possible for the flow of gas across the cathode side to be sufficient to remove this water nonetheless, which may result in the drying out of the membrane on the cathode side as well.

Accordingly, as the surface of the membrane must remain moist at all times, in order to ensure adequate efficiency, the process gases must, on entering the fuel cell, be of an appropriate temperature and humidity, based on requirements of the fuel cell system.

A further consideration is that there is an increasing interest in using fuel cells in transport and like applications, e.g. as the basic power source for cars, buses and even larger vehicles. Automotive applications are quite different from many stationary applications. For example, in stationary applications, fuel cell stacks are commonly used as an electrical power source and are expected to run at a relatively constant power level for an extended period of time. In contrast, in automotive applications, the actual power required from a fuel cell stack can vary widely. Additionally, the fuel cell stack supply unit is expected to respond rapidly to changes in power demand, whether these are demands for increased or reduced power, while maintaining high efficiencies. Further, for automotive applications, a fuel cell power unit may be expected to operate under an extreme range of ambient temperature and humidity conditions.

These requirements can be exceedingly demanding, and make it difficult to ensure that a fuel cell stack will operate efficiently under the entire range of possible operating conditions. While it is desirable to ensure that a fuel cell power unit can always supply a high power level and at a high efficiency while simultaneously ensuring that the unit has a long life, accurately controlling humidity levels within the fuel cell power unit is necessary in order for these requirements to be met. More particularly, it is necessary to control humidity levels in both the oxidant and fuel gas streams. Most known humidification techniques used in fuel cell systems are ill-designed to respond to rapidly changing conditions, temperatures, and the like. These systems provide inadequate humidification levels, and may have high thermal inertia and/or large dead volumes, so as to render them incapable of rapid response to changing conditions.

### SUMMARY OF THE INVENTION

Embodiments of the invention relate generally to a fuel cell management system that can facilitate rapid and accurate dynamic control of fuel cell system devices, and provide process control over varying operating conditions.

In one broad aspect of the invention, there is provided a fuel cell system comprising: a fuel cell stack comprising at least one fuel cell and electric outputs for driving a load; a balance of plant system for supplying and withdrawing process fluids to and from the fuel cell stack; and a controller that controls the operation of the fuel cell stack and the balance of plant system by measuring and setting process parameters, wherein the controller comprises a storage device for storing one or more process parameter control tables, each comprising stored values associated with a first process parameter as a function of a second process parameter; wherein in operation, the controller obtains a measured value for the second process parameter, and sets the first process parameter in the control of the fuel cell stack and the balance of plant system based on at least the measured value by retrieving, from at least one parameter control table, the stored value associated with the first process parameter that is a function of the second process parameter for which the measured value is obtained.

In another broad aspect of the invention, there is provided a fuel cell system comprising: a fuel cell stack having at least one fuel cell, the fuel cell stack having electric outputs for driving a load; a balance of plant system for supplying and withdrawing process fluids to and from the fuel cell stack; and a controller that controls the operation of the fuel cell stack and the balance of plant system by measuring and setting process parameters; the controller having a storage device which is adapted to, for at least one of the process parameters, store at least one current table of set values of the process parameter and to store at least one correction table of correction values of the process parameter; wherein correction table values are stored in real-time as changes are made to the process parameter by the controller according to information calculated from at least one of the current tables of at least one process parameter, and a value is calculated by the controller utilizing a set value read from the appropriate current table and which set value is re-calculated using a read correction value from an appropriate correction table for the process parameter.

In another broad aspect of the invention, there is provided a fuel cell system comprising: a fuel cell stack having at least one fuel cell, the fuel cell stack having electric outputs for driving a load; a balance of plant system for supplying and withdrawing process fluids to and from the fuel cell stack; and a controller that controls the operation of the fuel cell stack and the balance of plant system by measuring and setting process parameters; the controller having a storage device which is adapted to, for at least one of the process parameters, store at least one current table of set values of the process parameter; wherein current table values are stored in real-time as changes are made to the process parameter by the controller according to information calculated from at least one of the current tables of at least one process parameter.

### BRIEF DESCRIPTION OF THE DRAWINGS

For a better understanding of embodiments of the invention, reference will now be made, by way of example, to the accompanying drawings in which:

FIG. 1 is a schematic diagram of a fuel cell system in an embodiment of the invention;

FIG. 2 is a schematic x-y diagram illustrating the data of an example current table for a process parameter graphically;

FIG. 3 is a schematic x-y diagram illustrating the data of an example correction table for a process parameter graphically; and

FIG. 4 is a flowchart illustrating steps in a method of regulating the operation of a fuel cell system in an embodiment of the invention.

### DETAILED DESCRIPTION OF THE EMBODIMENTS OF THE INVENTION

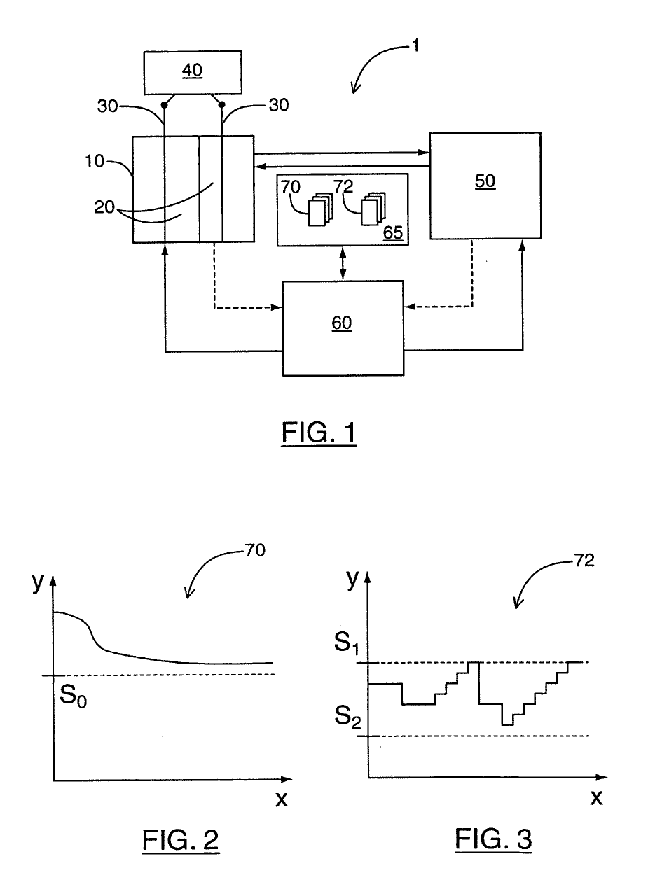

Referring to FIG. 1, a schematic diagram of a fuel cell system in an embodiment of the invention is shown generally as 1. Fuel cell system 1 comprises a fuel cell stack 10 having at least one fuel cell 20. Fuel cell stack 10 also provides electric outputs 30 for driving a load 40. A balance of plant system 50 (BOP) supplies and withdraws process fluids to and from fuel cell stack 10. The process fluids may include water, hydrogen and air, for example.

Fuel cell system 1 also comprises a controller 60, which controls various process devices [not shown] of fuel cell system 1, such as coolant pumps, blowers, and pressure regulators, for example. Controller 60 can be either a central controller, or comprise one or more local controllers, each typically controlling the operation of one or a few process devices.

Controller 60 controls the operation of fuel cell stack 10 and BOP 50 by measuring and setting process parameters, such as temperature (e.g. which may be controlled via coolant flows), air blower speed, current and voltage, for example. Another example of a process parameter that can be controlled by controller 60 is stoichiometry, for example, the amount of hydrogen gas provided to fuel cell stack 10 in relation to the theoretical value of gas that would be consumed under ideal conditions at the particular temperature and pressure.

For example, when controller 60 reads measured process parameter values indicating fuel cell stack 10 is operating under normal conditions, the stoichiometric balance of the hydrogen gas may be changed so that the stoichiometric relation is lowered (e.g. by lowering the hydrogen pressure in the hydrogen in-feed [not shown] to fuel cell stack 10). Conversely, when controller 60 reads measured process parameters indicating that fuel cell stack 10 is not operating under normal conditions, the stoichiometric balance of the hydrogen gas may be changed so that the stoichiometric relation is increased (e.g. by increasing the hydrogen pressure in the hydrogen in-feed to fuel cell stack 10).

It will be understood by persons skilled in the art that the process parameters noted above are provided by way of example only, and that embodiments of the invention may be employed in association with other process parameters in variant implementations.

Controller 60 comprises a storage device 65 for storing at least one process parameter control table. Storage device 65 may be provided as a separate device coupled to controller 60, or may exist as a memory store integrated into controller 60, for example.

In one embodiment of the invention, the process parameter control tables stored in storage device 65 comprise at least one baseline table and at least one correction table. These tables are discussed in greater detail with reference to the example depicted by FIGS. 2 and 3. In that example, each baseline table is a current table 70 of set values of a particular process parameter as a function of fuel cell stack current. Similarly, each correction table is a table of correction values 72 of the particular process parameter as a function of fuel cell stack current. The process parameter control tables may be used to control the operations of BOP 50. For instance, based on the values read from current table 70 and a corresponding correction table 72, the cathode flow rate and/or the anode purge rate within fuel cell stack 10 can be adjusted.

In variant implementations, the process parameter control tables may store values of process parameters that are a function of a different reference parameter. For example, values associated with a cathode stoichiometric offset as a function of stack temperature may be stored in a process parameter control table, for example.

In one embodiment of the invention, the values in a current table 70 of a particular process parameter are pre-determined and stored therein as a permanent data set. In order to change these set values, a new current table would have to be calculated according to new process data, and the new table stored in storage device 65. For example, the values in a current table 70 may be determined initially at the time of manufacture of fuel cell system 1, and new current tables may be subsequently calculated as necessitated by changes to the process (i.e. how BOP 50 is operated) or when new-found knowledge is had relating to the fuel cell system regulation process.

Referring to FIG. 2, a schematic x-y diagram illustrating the data of an example current table for a process parameter is shown graphically as 70. In this example, current table 70 illustrates stoichiometric values as a function of measured fuel cell stack current. FIG. 2 shows how the set value of the stoichiometric value of hydrogen gas (y-axis), as defined in a particular current table 70, slowly approaches a theoretical value S₀ as the value of the measured fuel cell stack current (x-axis) increases.

In one implementation, data in current table 70 (and corresponding correction table 72) can be stored in bins (e.g. 0-25, 25-50, 50-75, etc.); when the fuel cell stack current falls within a particular bin, the corresponding value of that bin (e.g. for the cathode flow rate and/or the anode purge rate) can be applied.

In this embodiment where the values in a current table 70 are stored therein as a permanent data set, values are stored and updated in a correction table 72 by the controller 60 in real-time, as changes are made to the associated process parameter by controller 60, as described with reference to FIG. 3.

Referring to FIG. 3, a schematic x-y diagram illustrating the data of an example correction table for a process parameter is shown graphically as 72.

FIG. 3 shows an example correction table 72 used for stoichiometric value adjustments for hydrogen gas. In this example implementation, correction table 72 stores incremental (+/−) adjustments, which are used with baseline operating values (e.g. from current table 70) to produce a final setpoint.

In this embodiment, as controller 60 calculates a new stoichiometric value for a given set of operating conditions, the value is stored in storage device 65 as a correction value in correction table 72. Whenever fuel cell system 1 is run under similar conditions again, controller 60 can retrieve the appropriate stoichiometric values from current table 70 and correction table 72, apply the correction value from correction table 72 to the value from current table 70, and accordingly, set the process parameter in operating BOP 50 to control fuel cell stack 10. In this way, controller 60 is adapted to “learn” how to run fuel cell system 1 efficiently, even as the system degrades with time or when other factors make it necessary to compensate the set values from the current table(s) 70.

As a further example to illustrate how the values from the current table 70 and correction table 72 may be used to pre-determine various operating parameters for BOP 50, if at one instance the fuel cell stack 10 was operating at 100 amps and it was necessary to change the stoichiometric balance by increasing the cathode flow to maintain stability, it is likely that if the fuel cell stack 10 were to operate at 150 amps and then return to 100 amps shortly thereafter, it would be necessary to change the stoichiometric balance in a similar way (i.e. by increasing the cathode flow) to achieve stability. The requisite stoichiometric values are memorized in the process parameter control tables to allow these adjustments to be made more efficiently.

Accordingly, the values in correction tables 72 may be set or adjusted if fuel cell stack 10 is unstable at a current operating point, or if performance of fuel cell stack 10 can be improved. Other data stored in storage device 65 pertaining to stack health parameters measured by controller 60 (e.g. stack impedance, minimum/maximum/average stack voltage) may also be used to update a correction table 72 for a process parameter. Optionally, minimum and maximum allowable stoichiometric correction values S1 and S2 (e.g. as shown in FIG. 3) respectively may be designated.

In a variant embodiment, stored values from different correction tables may also be used by controller 60 to calculate correction values for a correction table 72, and possibly to generate additional correction tables for other process parameters, for example.

It will be understood by persons skilled in the art, that although FIGS. 2 and 3 illustrate an example of stoichiometric value control, embodiments of the invention can be applied to the regulation of other process parameters.

In operation, controller 60 makes changes to process parameters governing fuel cell stack 10 according to operating conditions, and can be changed to optimize system performance and stability. Performance may be defined as system efficiency, system response and system durability. In one embodiment, process parameters are changed based on calculations made using data from at least one current table 70 of at least one process parameter, and possibly from other measured process data.

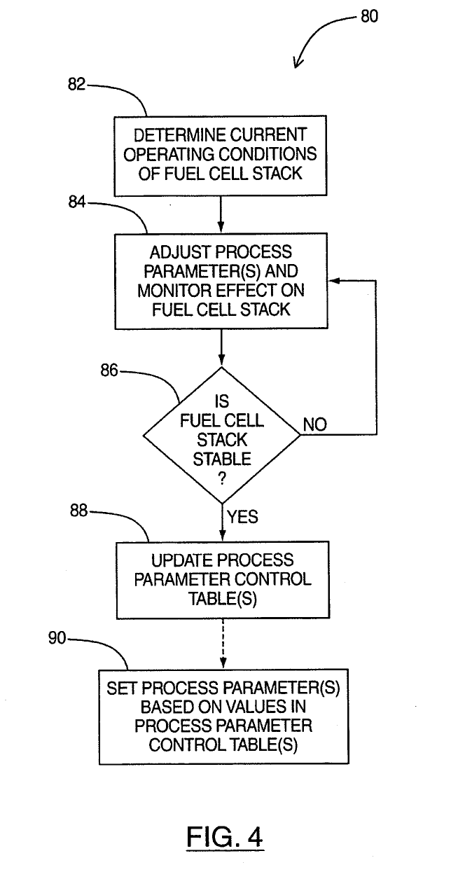

For example, referring to FIG. 4, a flowchart illustrating steps in a method of regulating the operation of a fuel cell system in an embodiment of the invention is shown generally as 80. At step 82, controller 60 receives measurements of process parameters relating to current operating conditions of fuel cell stack 10, and determines, for example, that fuel cell stack 10 is becoming unstable. At step 84, controller 60 adjusts one or more process parameters and monitors the effect of the adjustments (e.g., controller 60 may increase the anode purge rate by 2% from a baseline value as stored in current table 70, and check for the effect of the increased purge rate). At step 86, controller 60 makes a determination if the fuel cell stack 10 has become stable. If the fuel cell stack 10 is stable, the corresponding correction table 72 is updated to indicate what adjustments are needed at the current fuel cell stack current setting at step 88 (e.g., the purge rate is to be set 2% higher than the associated baseline value at the given fuel cell stack current). If the fuel cell stack 10 is not stable, further adjustments to process parameters can be made.

Subsequently, at step 90, process parameters may be set by controller 60 based upon stored values in correction table 72 (used to store adjustments to baseline values stored in current table 70, in this example), when fuel cell stack 10 operates under similar conditions (e.g. at the same fuel cell stack current setting). Controller 60 may make further adjustments to process parameters (and update correction table 72 accordingly), if it determines that further adjustments are necessary to keep the fuel cell stack 10 stable or to otherwise improve performance.

In a variant embodiment of the invention, controller 60 may store a re-calculated operating value determined based on actual operating conditions for a particular process parameter directly in the appropriate location of a baseline table (e.g. current table 70), replacing the most recently set value. In this embodiment, a separate correction table (e.g. correction table 72) is not required.

In a variant embodiment of the invention, one process parameter control table is provided for a particular process parameter, where the process parameter control table includes both an area for storing calculated correction values and an area for storing current table values.

In a variant embodiment of the invention, back-up versions of any of the process parameter control tables used may be made and stored. In this way, controller 60 can retrieve a back-up table should the original table being used become corrupt or un-readable, for instance.

Process parameter control tables may be saved in non-volatile storage as updates are made. In a variant embodiment, process parameter control tables may be stored in a volatile memory during operation, and saved either at regular intervals and/or when controller 60 is shut down.

Embodiments of the invention provide some advantages over existing fuel cell systems. For example, by utilizing a fuel cell system constructed in accordance with an embodiment of the invention, sensor measurement errors may be eliminated to a large degree since the system can automatically adapt to changing conditions efficiently, and control process parameters to improve system performance and stability accordingly.

It will be understood by persons skilled in the art that embodiments of the invention may have applicability in different types of fuel cells, which include but are not limited to, solid oxide, alkaline, molten-carbonate, and phosphoric acid.

The invention has been described with regard to a number of embodiments. However, it will be understood by persons skilled in the art that other variants and modifications may be made without departing from the scope of the invention as defined in the claims appended hereto.

1. A fuel cell system comprising:
a) a fuel cell stack comprising at least one fuel cell and electric outputs for driving a load;
b) a balance of plant system for supplying and withdrawing process fluids to and from the fuel cell stack; and
c) a controller that controls the operation of the fuel cell stack and the balance of plant system by measuring and setting process parameters, wherein the controller comprises a storage device for storing one or more process parameter control tables, each comprising stored values associated with a first process parameter as a function of a second process parameter;
wherein in operation, the controller obtains a measured value for the second process parameter, and sets the first process parameter in the control of the fuel cell stack and the balance of plant system based on at least the measured value by retrieving, from at least one parameter control table, the stored value associated with the first process parameter that is a function of the second process parameter for which the measured value is obtained.

2. The system of claim 1, wherein values are stored in at least a subset of the one or more process parameter control tables in real-time by the controller, as changes are made to the respective first process parameter by the controller in response to a change in operating conditions in the fuel cell system.

3. The system of claim 1, wherein the one or more process parameter control tables comprise one or more baseline tables of values of the first process parameter and one or more corresponding correction tables of the first process parameter.

4. The system of claim 3, wherein values in the one or more correction tables are stored in real-time by the controller, as changes are made to the respective first process parameter by the controller in response to a change in operating conditions in the fuel cell system; and wherein in operation, the controller sets the first process parameter based on at least the measured value for the second process parameter by retrieving, from at least one of the one or more baseline tables, the stored value associated with the first process parameter that is a function of the second process parameter for which the measured value is obtained, and further adjusting the stored value using a corresponding correction value from at least one of the one or more correction tables.

5. The system of claim 1, wherein the second process parameter is associated with fuel cell stack current.

6. The system of claim 1, wherein the first process parameter is associated with a stoichiometric value.

7. A method of regulating the operation of a fuel cell system, wherein the fuel cell system comprises a fuel cell stack, the fuel cell stack comprising at least one fuel cell and electric outputs for driving a load, a balance of plant system for supplying and withdrawing process fluids to and from the fuel cell stack, and a controller that controls the operation of the fuel cell stack and the balance of plant system by measuring and setting process parameters, wherein the controller comprises a storage device, and wherein the method comprises the steps of:
a) providing one or more process parameter control tables for storage in the storage device, each process parameter control table comprising stored values associated with a first process parameter as a function of a second process parameter;
b) receiving process parameter measurements relating to current operating conditions of the fuel cell stack;
c) making adjustments to at least a first process parameter governing operation of the fuel cell stack, and monitoring changes to the fuel cell stack resulting therefrom, the state of the changed fuel cell stack defined by at least a measured value of the second process parameter;
d) storing a value for the first process parameter as a function of the second process parameter reflecting the adjustments made at step c) in at least one process parameter control table;
e) employing one or more values stored at step d) in setting the first process parameter to control the operation of the fuel cell stack and the balance of plant system, when the fuel cell stack subsequently obtains a state defined by at least the measured value of the second process parameter of step c).

8. The method of claim 7, wherein the one or more process parameter control tables comprise one or more baseline tables of values of the first process parameter and one or more corresponding correction tables of the first process parameter.

9. The method of claim 8, wherein values stored at step d) are stored in the one or more correction tables, and wherein step e) comprises employing the stored values in setting the first process parameter based on at least the measured value for the second process parameter by retrieving, from at least one of the one or more baseline tables, the stored value associated with the first process parameter that is a function of the second process parameter at the associated measured value, and further adjusting the stored value using a corresponding correction value from at least one of the one or more correction tables.

10. The method of claim 7, wherein the second process parameter is associated with fuel cell stack current.

11. The method of claim 7, wherein the first process parameter is associated with a stoichiometric value.
